(19) United States
(12) Patent Application Publication
(10) Pub. No.: US 2024/0071650 A1
(43) Pub. Date: Feb. 29, 2024

(54) PANE WITH ELECTRIC CONNECTION ELEMENT

(71) Applicant: SAINT-GOBAIN GLASS FRANCE, COURBEVOIE (FR)

(72) Inventors: Katja HELWER, SIMMERATH (DE); Bernhard REUL, HERZOGENRATH (DE); Mitja RATEICZAK, WÜRSELEN (DE)

(21) Appl. No.: 18/260,144

(22) PCT Filed: Dec. 22, 2021
(86) PCT No.: PCT/EP2021/087413

§ 371 Date: Jun. 30, 2023

(30) Foreign Application Priority Data
Jan. 6, 2021 (EP) 21150437.8

(51) Int. Cl. H01B 9/00; B23K 1/00; H01R 4/02; H01R 4/18

(52) U.S. Cl. CPC H01B 9/006; B23K 1/0016; H01R 4/02; H01R 4/182; H05B 3/84

(57) ABSTRACT

A pane with at least one electric connection element includes a flat substrate, an electrically conductive coating on the flat substrate, on the electrically conductive coating, an electric connection element having a region crimped about a connection cable, wherein the crimped region is electrically conductively connected to the electrically conductive coating via a soldering compound, a corrosion-inhibiting coating, which is applied, adjacent the soldering compound, on the electrically conductive coating and, at least in sections, on the soldering compound, wherein the corrosion-inhibiting coating is made of an electrically insulating material that protects against moisture, wherein the corrosion-inhibiting coating (i) only partially covers the soldering compound and does not cover the crimped region of the connection element, or (ii) completely covers the soldering compound and only partially covers the crimped region of the connection element.

The invention is in the technical field of pane production and relates to a pane with an electric connection element, as well as a method for its production, and its use.

Panes in buildings and vehicles are increasingly provided with large-area, electrically conductive layers transparent to visible light that must fulfill certain functions (functional layers).

In particular, for reasons of energy saving and comfort, high demands are placed on panes with regard to their heat insulating properties. For example, it is desirable to avoid high heat input from solar radiation, which results in excessive heating of the interior and, in turn, results in high energy costs for the necessary air conditioning. This is remedied by electrochromic layer systems by which the light transmittance and consequently the heat input due to sunlight can be controlled by applying an electrical voltage. Electrochromic layer systems are known, for example, from EP 0867752 A1, US 2007/0097481 A1, and US 2008/0169185 A1.

Another function of electrically conductive layers aims to keep the field of vision of a vehicle pane free of ice and condensation. Electric heating layers are known (see, for example, WO 2010/043598 A1) that cause targeted heating of the pane by applying an electrical voltage. The electrical contacting of the heating layer is accomplished by bus bars that typically run along the upper and lower edge of the pane. The bus bars collect the current that flows through the electric heating layer and conduct it to external leads connected to a voltage source. The voltage applied to the electric heating layer is usually controlled by external switches that are, for example, integrated in a dashboard in vehicles.

It is also known to use electrically conductive layers as planar antennas (see, for example, DE 10106125 A1, DE 10319606 A1, EP 0720249 A2, US 2003/0112190 A1, and DE 19843338 C2). For this purpose, the layer is galvanically or capacitively coupled to a coupling electrode, and the antenna signal is made available in the edge region of the pane. The antenna signal coupled out of the planar antenna is fed to an antenna amplifier, which, in motor vehicles, is connected to the metallic body, thus providing a high-frequency reference potential effective for the antenna signal.

Electrically conductive functional layers are generally electrically contacted by electric connection elements with solder connection surfaces on the pane surface. The solder forms an electrical connection and often a mechanical connection as well between the functional layers and the leads that are connected to the connection element.

The soldering operation can, for example, be carried out by a contact soldering method in which two electrodes are placed on the connection element at a certain distance from one another. Then, the connection element is heated by means of ohmic resistance heating by an electric current that flows from one electrode to the other. Alternatively, the soldering operation can be carried out by induction soldering. Such a method is known, for example, from DE 10 2004 057 630 B3.

Due to different coefficients of thermal expansion of the materials used for the soldered connection, mechanical stresses occur during production and operation, which stress the panes and can cause breakage of the pane. Lead-containing solders generally have high ductility that can compensate the mechanical stresses occurring between the electric connection element and the pane by plastic deformation. However, due to legal regulations lead-containing solders must be replaced by leadfree solders, which have lower ductility. A number of electric connection elements for leadfree soldering with electrically conductive coatings have been proposed. Reference is made, by way of example, to the documents US 20070224842 A1, EP 1942703 A2, WO 2007110610 A1, EP 1488972 A1, and EP 2365730 A1. The shape of the connection element on the one hand and the material of the connection element on the other are of critical importance for avoiding thermally induced mechanical stresses, with chromium-containing steel having proved to be advantageous in this respect.

Practice has now shown that the solder joints between electrically conductive coatings and connection elements can have reduced mechanical stress properties over time. This can result in an undesirable functional failure of the functional surface and can possibly result in relatively high costs for repair or exchange of the pane. In general, it would be desirable to have a pane with at least one electric connection element that permanently has a higher pull-off force such that this problem does not occur and associated costs can be avoided.

A connection element encapsulated by a potting compound can be found in each of the documents US 2016/001744 A1 and US 2018/014361 A1.

In contrast, the object of the present invention consists in making available an improved pane with at least one electric connection element with which these disadvantages can be avoided. The pane should be simple and economical to produce in industrial series production.

These and other objects are accomplished according to the proposal of the invention by a pane with at least one electric connection element in accordance with the independent claim. Advantageous embodiments of the invention are evident from the dependent claims.

According to the invention, a pane with at least one electric connection element is shown. It comprises a (flat) substrate and a (flat) electrically conductive coating that is applied on a region of the substrate. The pane further comprises an electric connection element that has a region crimped about a connection cable, with the crimped region electrically conductively connected to the electrically conductive coating via a soldering compound.

It is essential to additionally use a corrosion-inhibiting coating, which is applied, adjacent the soldering compound, to the electrically conductive coating and, at least in sections, to the soldering compound. The corrosion-inhibiting coating is made of an electrically insulating material that protects the underlying structures against moisture. The corrosion-inhibiting coating is preferably implemented in the form of a continuous coating.

As the inventors found, a major cause of weakening of the solder joint possibly occurring over time is corrosion of the electrically conductive coating triggered by moisture entering from the environment (electro-corrosion). A resulting chemical change in the electrically conductive coating weakens the mechanical connection between the solder and the electrically conductive coating such that the connection element detaches even with slight pulling. This applies especially to silver-based electrically conductive coatings applied to the substrate, for example, by printing and baked by sintering. The electrically conductive coating is protected against moisture in the region of the solder joint by the corrosion-inhibiting coating such that its corrosion can advantageously be inhibited. For this purpose, the corrosion-inhibiting coating is applied, adjacent the soldering compound, to the electrically conductive coating and extends at least over a region of the soldering compound. The penetration of moisture into the electrically conductive coating in the region of the solder joint can thus be reliably and safely prevented. Moreover, in addition to the chemical stability of the electrically conductive coating, the corrosion-inhibiting coating can also advantageously improve the mechanical stability of the solder joint. The solder joint thus established between the connection element and the electrically conductive coating is, in particular, sufficiently strong to be used even in a heating field of a pane, in particular of a vehicle window where there are special requirements for resistance to thermal shock.

The corrosion-inhibiting coating consists of a material that protects against moisture. The coating is a barrier against liquid water and water vapor and thus limits entry of water-vapor from the environment into the electrically conductive coating. Preferably, the permeability to water-vapor is less than 100 g/(day×m²) and in particular less than 10 g/(day×m²), measured in accordance with the ASTM E96-10 method. The corrosion-inhibiting coating can, in particular, also be water-vapor-tight, with permeability to water-vapor so low that is negligible.

In accordance with one embodiment of the pane with an electric connection element, the corrosion-inhibiting coating covers the soldering compound only partially, i.e., not completely. On the one hand, this is advantageous in terms of reliable and safe prevention of corrosion of the electrically conductive coating. On the other hand, material costs can advantageously be saved in industrial series production.

However, it is also possible for the corrosion-inhibiting coating to completely cover the soldering compound. This can particularly effectively prevent the access of moisture to the electrically conductive coating in the region of the solder joint. In accordance with another embodiment of the pane with an electric connection element according to the invention, the corrosion-inhibiting coating covers the soldering compound completely and covers the crimped region of the connection element only partially, i.e., not completely. In addition to good corrosion inhibition, a significant improvement in the chemical stability of the solder joint can thus be achieved.

According to the invention, the corrosion-inhibiting coating does not completely cover the crimped region of the connection element and the soldering compound, i.e., does not encapsulate the connection element and the soldering compound.

The corrosion-inhibiting coating can, in principle, be made of any material, provided sufficient protection of the electrically conductive coating in the region of the solder joint against moisture from the environment is achieved. Advantageously, the corrosion-inhibiting coating contains or consists of a sealant conventionally used in window manufacture, for example butyl (polyisobutylene). The sealant seals the underlying coatings air tightly against the external environment. It is also possible, for example, for the corrosion-inhibiting coating to contain or consist of a flux, a primer, a paint, a hot adhesive, or a foam tape. These substances are well-known to the person skilled in the art. Foam tapes are commercially available. By using these substances, good corrosion inhibition and significantly improved mechanical stability of the solder joint can advantageously be achieved.

If a flux is used as the corrosion-inhibiting coating, the flux advantageously has high rosin content. If a primer is used as the corrosion-inhibiting coating, the primer used advantageously contains polyisocyanates. If a foam tape is used as the corrosion-inhibiting coating, it advantageously contains acrylic or acrylate foam. This is particularly advantageous in terms of the required corrosion inhibition and, at the same time, enables a particularly stable connection between the connection element and the electrically conductive coating.

As already stated, the-corrosion-inhibiting coating in the region of the solder joint is intended to inhibit or prevent access of moisture from the environment to the electrically conductive coating in the region of the solder joint. For this purpose, the corrosion-inhibiting coating is applied, adjacent the soldering compound, to the electrically conductive coating. Particularly advantageously, the corrosion-inhibiting coating on the electrically conductive coating always has a dimension of at least 1 mm, in particular of 1 mm to 4 mm, starting from the soldering compound and in a direction parallel to the substrate surface, in particular perpendicular to the soldering compound. By means of this measure, on the one hand, good corrosion inhibition and mechanical stabilization of the solderjoint is achieved, and on the other, material costs can be saved and the space required for the corrosion-inhibiting coating can be reduced.

The substrate is flat and preferably contains or consists of glass, in particular flat glass, float glass, quartz glass, borosilicate glass, and/or soda lime glass. However, the substrate can also contain or consist of polymers, preferably polyethylene, polypropylene, polycarbonate, polymethyl methacrylate, polystyrene, polybutadiene, polynitriles, polyesters, polyurethane, polyvinyl chloride, polyacrylate, polyamide, polyethylene terephthalate, and/or copolymers or mixtures thereof. The substrate is in particular transparent. The substrate has, for example, a thickness of 0.5 mm to 25 mm, or of 1 mm to 10 mm, in particular of 1.5 mm to 5 mm.

The electrically conductive coating (e.g., functional layer) is arranged on a surface of the substrate and covers the surface of the substrate partially, but preferably over a large area. The expression “over a large area” means that at least 50%, at least 60%, at least 70%, at least 75%, or preferably at least 90% of the surface of the substrate is covered by the electrically conductive coating (e.g., coated). However, the electrically conductive coating can also extend over smaller proportions of the surface of the substrate, for example, when it is a special connection surface, in particular a bus bar. The electrically conductive coating is preferably transparent to visible light. In an advantageous embodiment, the electrically conductive coating is a single layer or a layer structure comprising a plurality of single layers with a total thickness less than or equal to 2 μm, particularly preferably less than or equal to 1 μm.

In the context of the present invention, “transparent” means that the total transmittance of the pane complies with the legal regulations for windshields and front side windows in motor vehicles and preferably has, for visible light, transmittance of more than 70% and in particular of more than 75%. For rear side windows and rear windows, “transparent” can also mean 10% to 70% light transmittance. Accordingly, “opaque” means light transmittance of less than 15%, preferably less than 5%, in particular 0%.

For example, the electrically conductive coating contains at least one metal, preferably silver, nickel, chromium, niobium, tin, titanium, copper, palladium, zinc, gold, cadmium, aluminum, silicon, tungsten, or alloys thereof, and/or at least one metal oxide layer, preferably tin-doped indium oxide (ITO), aluminum-doped zinc oxide (AZO), fluorine-doped tin oxide (FTO, SnO2:F), or antimony-doped tin oxide (ATO, SnO2:Sb). Transparent, electrically conductive layers are known, for example, from DE 20 2008 017 611 U1 in EP 0 847 965 B1. They consist, for example, of a metal layer such as a silver layer or a layer of a silver-containing metal alloy. Transparent, electrically conductive layers preferably have sheet resistance of 0.1 ohm/square to 200 ohm/square, particularly preferably of 1 ohm/square to 50 ohm/square, and most particularly preferably of 1 ohm/square to 10 ohm/square.

According to a particularly advantageous embodiment of the pane according to the invention with an electric connection element, the electrically conductive coating contains at least silver, in particular silver particles and glass frits, and has, for example, a layer thickness of 5 μm to 40 μm.

The electrically conductive coating can be, for example, an electrically heatable layer, which provides the pane with a heating function. Such heatable layers are known per se to the person skilled in the art. They typically contain one or more, for example, two, three, or four electrically conductive layers. These layers preferably contain or consist of at least one metal, for example, silver, gold, copper, nickel, and/or chromium, or a metal alloy and preferably contain at least 90 wt-% of the metal, in particular at least 99.9 wt-% of the metal. Such layers have particularly advantageous electrical conductivity with, at the same time, high transmittance in the visible spectral range. The thickness of a single layer is preferably from 5 nm to 50 nm, particularly preferably from 8 nm to 25 nm, by means of which advantageously high transmittance in the visible spectral range and particularly advantageous electrical conductivity are achieved.

The electrically heatable coating is electrically connected, for example, to at least two bus bars by means of which a heating current can be fed into the coating. The bus bars are preferably arranged on the electrically conductive layer in the edge region of the electrically conductive coating along one side edge. The length of the bus bar is typically substantially equal to the length of the side edge of the electrically conductive coating, but can also be somewhat greater or less. Preferably, two bus bars are arranged on the electrically conductive layer, in the edge region along two opposite side edges of the electrically conductive coating. The width of the bus bar is preferably from 2 mm to 30 mm, particularly preferably from 4 mm to 20 mm. The bus bars are typically implemented in each case in the shape of a strip, with its longer dimensions referred to as length and its less longer dimensions referred to as width. Bus bars are, for example, implemented as printed and baked structures. The printed bus bar contains at least one metal, preferably silver. The electrical conductivity is preferably realized via metal particles contained in the bus bar, particularly preferably via silver particles. The metal particles can be situated in an organic and/or inorganic matrix such as pastes or inks, preferably as baked screen print paste with glass frits. The layer thickness of the printed bus bar is preferably from 5 μm to 40 μm, particularly preferably from 8 μm to 20 μm, and most particularly preferably from 10 μm to 15 μm. Printed bus bars with these thicknesses are technically easy to realize and have an advantageous current-carrying capacity.

For example, the electrically conductive coating is applied to the substrate by vapor deposition, chemical vapor deposition (CVD), plasma-enhanced chemical vapor deposition (PECVD), or by wet chemical methods. Preferably, this is done by magnetron-enhanced cathodic sputtering, which is particularly advantageous in terms of simple, quick, economical, and uniform coating. Alternatively, it is applied to the substrate by printing, in particular screen printing, or by other common application methods such as brushing, rolling, spraying, and the like, and preferably subsequently baked. Sintered coatings, in particular silver-containing coatings, are particularly susceptible to corrosion-induced reduction in the mechanical strength of solder joints.

According to a preferred embodiment of the pane according to the invention with an electric connection element, the soldering compound is leadfree, which is particularly advantageous in terms of the environmental compatibility of the pane according to the invention with an electric connection element. In the context of the present invention, “leadfree” means that the soldering compound has a content less than or equal to 0.1 wt-% of lead, in particular no lead, i.e., 0 wt-% of lead.

Leadfree soldering compounds typically have lower ductility than lead-containing soldering compounds such that mechanical stresses between the connection element and the substrate cannot be compensated as well. The corrosion-inhibiting coating used according to the invention can particularly advantageously improve the mechanical stability of the solder joint when using leadfree solders.

For example, the soldering compound contains tin, bismuth, indium, zinc, copper, or silver, in particular compositions thereof. For example, the content of bismuth, indium, zinc, copper, silver, or compositions thereof in the solder compound can be from 0.5 wt-% to 97 wt-%, in particular 10 wt-% to 67 wt-%, while the content of bismuth, indium, zinc, copper, or silver can be 0 wt-%. The soldering compound can contain nickel, germanium, aluminum, or phosphorus with a content from 0 wt-% to 5 wt-%. The soldering composition contains, in particular, Bi40Sn57Ag3, Sn40Bi57Ag3, Bi59Sn40Ag1, Bi57Sn42Ag1, In97Ag3, Sn95.5Ag3.8Cu0.7, Bi67In33, Bi33In50Sn17, Sn77.2In20Ag2.8, Sn95Ag4Cu1, Sn99Cu1, Sn96.5Ag3.5, Sn96.5Ag3Cu0.5, Sn97Ag3, or mixtures thereof.

The layer thickness of the soldering compound is preferably less than or equal to 6.0×10⁻⁴ m, in particular less than 3.0×10⁻⁴ m.

Advantageously, the soldering compound contains bismuth. It has been shown that a bismuth-containing soldering compound results in particularly good adhesion of the connection element to the substrate, making it possible to avoid damage to the pane. The content of bismuth in the soldering compound is, for example, from 0.5 wt-% to 97 wt-%, from 10 wt-% to 67 wt-%, or from 33 wt-% to 67 wt-%, in particular from 50 wt-% to 60 wt-%. In addition to bismuth, the soldering compound contains in particular tin and silver or tin, silver, and copper. For example, the soldering compound contains at least 35 wt-% to 69 wt-% bismuth, 30 wt-% to 50 wt-% tin, 1 wt-% to 10 wt-% silver, and 0 wt-% to 5 wt-% copper. In particular, the soldering compound contains at least 49 wt-% to 60 wt-% bismuth, 39 wt-% to 42 wt-% tin, 1 wt-% to 4 wt-% silver, and 0 wt-% to 3 wt-% copper. Furthermore, the soldering compound can contain, for example, from 90 wt-% to 99.5 wt-% tin, or from 95 wt-% to 99 wt-% tin, in particular from 93 wt-% to 98 wt-% tin. In addition to tin, the soldering compound contains, for example, from 0.5 wt-% to 5 wt-% silver and from 0 wt-% to 5 wt-% copper.

The soldering compound flows out, for example, from the intermediate space between the connection element and the electrically conductive coating with an outflow width of less than 1 mm. For example, the maximum outflow width is less than 0.5 mm and in particular approx. 0 mm. This is particularly advantageous in terms of the reduction of mechanical stresses in the pane and the adhesion of the connection element. The maximum outflow width is defined as the distance between the outer edges of the connection element and the point of the soldering compound crossover, where the soldering compound drops below a layer thickness of 50 μm. The maximum outflow width is measured on the solidified soldering compound after the soldering operation. A desired maximum outflow width is obtained through a suitable selection of the soldering compound volume and the vertical distance between the connection element and the electrically conductive coating, which can be determined by simple experiments. The vertical distance between the connection element and the electrically conductive coating can be predefined by an appropriate process tool, for example, a tool with an integrated spacer. The maximum outflow width can even be negative, i.e., pulled back into the intermediate space formed by the connection element and the electrically conductive coating. For example, the maximum outflow width is pulled back in a concave meniscus formed by the connection element and the electrically conductive coating. A concave meniscus is created, for example, by increasing the vertical distance between the spacer and the conductive coating during the soldering operation, while the solder is still fluid. The advantage resides in the reduction of the mechanical stresses in the pane, in particular in the critical region that is present with a large soldering compound crossover.

The corrosion-inhibiting coating is arranged, adjacent the soldering compound, on the electrically conductive coating, it being understood that only a region or part of the electrically conductive coating, which is adjacent the soldering compound, is coated by the the corrosion-inhibiting coating. The corrosion-inhibiting coating extends in any case all the way to the soldering compound in order to achieve reliable and safe protection against moisture of the region of the electrically conductive coating directly connected to the soldering compound.

For example, one or more contact bumps, which are used for the contacting of the connection element to the soldering tools during the soldering operation, are arranged on the side of the connection element facing away from the substrate. The contact bumps preferably have a height from 0.1 mm to 2 mm, in particular from 0.2 mm to 1 mm. The length and width of the contact bumps is, for example, from 0.1 mm to 5 mm, in particular from 0.4 mm to 3 mm. The contact bumps are in particular formed in one piece with the connection element, for example, by stamping or deep drawing.

For the soldering, electrodes whose contact side is flat can be used. The electrode surface is brought into contact with the contact bump. The electrode surface is arranged parallel to the surface of the substrate. The contact region between the electrode surface and the contact bump forms the soldering point. The position of the soldering point is determined by the point on the convex surface of the contact bump that has the greatest vertical distance from the surface of the substrate. The position of the soldering point is independent of the position of the soldering electrode on the connection element. This is particularly advantageous in terms of reproducible uniform heat distribution during the soldering operation. The heat distribution during the soldering operation is determined by the position, the size, the arrangement, and the geometry of the contact bump.

The connection element has a region crimped about a connection cable, but can also be implemented as a whole as a crimp, in particular as a B-crimp. The connection element itself is then a crimp, in particular a B-crimp.

The shape of the crimped region or the crimp is, in principle, arbitrary and can be determined by the person skilled in the art according to the requirements in the individual case through the selection of the crimping tool. The shape of the crimp is based on the cross-section of the crimp. The crimp-shaped region or the crimp can, for example, be implemented as an oval crimp, a polygonal crimp (for example, a square crimp, hexagonal crimp, or trapezoidal crimp), O-crimp, or B-crimp.

Advantageously, the connection element itself is implemented in the form of a crimp, in particular as an open crimp, in particular as a B-crimp, which enables simple production and automation, resulting in particular suitability for mass production.

According to one embodiment of the pane according to the invention with an electric connection element, the connection element has a material thickness of 0.1 mm to 2 mm. At a material thickness of 0.1 mm to 2 mm, the connection element has, on the one hand, the cold formability required for crimping. On the other hand, in this material thickness range, advantageous stability of the connection element is achieved.

The width of the connection element can be suitably selected by the person skilled in the art under consideration of the requirements as well as current standards and is, for example, from 1 mm to 5 mm or from 2 mm to 3 mm, in particular 2.5 mm. This is particularly advantageous in terms of a small space requirement for the connection element. In addition, a stable connection between the connection element and the connection cable is thus achieved.

The length of the connection element can be suitably selected by the person skilled in the art under consideration of the diameter of the connection cable as well as current standards and is, for example, from 2 mm to 8 mm, from 4 mm to 5 mm, or from 4.3 mm to 4.7 mm, in particular 4.5 mm. This is particularly advantageous in terms of a small space requirement for the connection element and in terms of a stable connection between the connection element and the connection cable.

The height of the connection element can be suitably selected by the person skilled in the art under consideration of the diameter of the connection cable as well as current standards and is, for example, from 1 mm to 5 mm or from 2 mm to 3 mm, in particular 2.5 mm. This is particularly advantageous in terms of a small space requirement for the connection element and in terms of a stable connection between the connection element and the connection cable.

In the case of an open crimp, the connection element is advantageously provided as a flat platelet or as a platelet pre-bent to form a crimp claw and is squeezed around the connecting cable to form the crimp. In the case of a closed crimp, the connection element is advantageously designed as a sleeve (wire end sleeve) and is squeezed around the connection cable.

The connection cable connects the connection element, i.e., the electrically conductive coating of the substrate, to an electrical system, such as an amplifier, control unit, or voltage source that is arranged outside the pane.

The connection element, i.e., the crimped region or the crimp, is preferably connected directly to the electrically conductive coating via the soldering compound. What is meant here is a direct mechanical connection between the connection element and the electrically conductive coating via the soldering compound. This means that the soldering compound is arranged between the connection element and the electrically conductive coating, and as a result stably fixes the connection element permanently on the electrically conductive coating. In particular, the entire connection element is connected to the electrically conductive coating via the soldering compound. This means that soldering compound is arranged along the entire length of the connection element. As a result, particularly stable adhesion of the connection element to the electrically conductive coating is achieved. However, it is also possible for the soldering compound to be arranged only between a section of the connection element and the electrically conductive coating. It is also possible for a special connection surface, for example, a bus bar, to be arranged on the electrically conductive coating and for the connection element to be directly connected electrically to the connection surface.

According to one embodiment of the pane according to the invention with an electric connection element, the difference between the coefficient of thermal expansion of the substrate and the coefficient of thermal expansion of the connection element is less than 5×10⁻⁶/° C., in particular less than 3×10⁻⁶/° C. Thus, the thermal stresses on the pane are reduced and better adhesion is achieved.

The coefficient of thermal expansion of the substrate is, for example, from 8×10⁻⁶/° C. to 9×10⁻⁶/° C. The substrate contains, for example, glass, which has, in particular, a coefficient of thermal expansion from 8.3×10⁻⁶/° C. to 9×10⁻⁶/° C. in a temperature range from 0° C. to 300° C.

The coefficient of thermal expansion of the connection element is, for example, from 9×10⁻⁶/° C. to 13×10⁻⁶/° C., or from 10×10⁻⁶/° C. to 11.5×10⁻⁶/° C., in particular from 10×10⁻⁶/° C. to 10.5×10⁻⁶/° C. in a temperature range from 0° C. to 300° C.

The connection element preferably contains or consists of a chromium-containing steel having a chromium content greater than or equal to 10.5 wt-%. Other alloy components such as molybdenum, manganese, or niobium result in improved corrosion resistance or modified mechanical properties, such as tensile strength or cold formability. For example, the connection element, can also contain admixtures of other elements, including vanadium, aluminum, and nitrogen. Particularly suitable chromium-containing steel are steels with the material numbers 1.4016, 1.4113, 1.4509, and 1.4510 per EN 10088-2.

According to one embodiment of the pane according to the invention with an electric connection element, the connection element contains or consists of at least 66.5 wt-% to 89.5 wt-% iron, 10.5 wt-% to 20 wt-% chromium, 0 wt-% to 1 wt-% carbon, 0 wt-% to 5 wt-% nickel, 0 wt-% to 2 wt-% manganese, 0 wt-% to 2.5 wt-% molybdenum, 0 wt-% to 2 wt-% niobium, and 0 wt-% to 1 wt-% titanium, in particular at least 77 wt-% to 84 wt-% iron, 16 wt-% to 18.5 wt-% chromium, 0 wt-% to 0.1 wt-% carbon, 0 wt-% to 1 wt-% manganese, 0 wt-% to 1 wt-% niobium, 0 wt-% to 1.5 wt-% molybdenum, and 0 wt-% to 1 wt-% titanium.

For example, the electric connection element has, at least on the surface oriented toward the soldering compound, a coating that contains copper, zinc, tin, silver, gold, or alloys or layers thereof, preferably silver. Thus, improved wetting of the connection element with the soldering compound and improved adhesion of the connection element are achieved.

For example, the connection element is coated with nickel, tin, copper, and/or silver. The connection element is provided, in particular, with an adhesion-promoting layer, for example, of nickel and/or copper, and additionally, with a solderable layer, in particular of silver. The connection element is, in particular, coated with 0.1 μm to 0.3 μm nickel and/or 3 μm to 20 μm silver. The connection element can be plated with nickel, tin, copper, and/or silver. Nickel and silver improve the current-carrying capacity and corrosion stability of the connection element and the wetting with the soldering compound.

The invention further extends to a method for producing a pane according to the invention with an electric connection element. The above statements concerning the pane according to the invention apply equally to the method according to the invention.

Here, in a first step (S1), soldering compound is applied to the underside of the connection element and/or to the electrically conductive coating. In another step (S2), the connection element with interposed soldering compound is arranged on a region of the electrically conductive coating. In a subsequent step (S3), the connection element is connected, with energy input, to the electrically conductive coating. In another step (S4), a corrosion-inhibiting coating adjacent the soldering compound is applied to the electrically conductive coating and, at least in sections, to the soldering compound, with the corrosion-inhibiting coating consisting of an electrically insulating material that protects against moisture.

The soldering compound is preferably applied to the connection element and/or the electrically conductive coating as platelets with defined layer thickness, volume, shape, and arrangement. The layer thickness of the soldering compound platelet is, for example, less than or equal to 0.6 mm. The soldering compound platelet has, for example, a rectangular shape. The underside of the connection element is the side that is intended to be arranged facing the substrate, on the electrically conductive coating.

The introduction of energy during the electrical connecting of the electric connection element and the electrically conductive coating is preferably carried out using a stamp, thermodes, piston soldering, in particular laser soldering, hot air soldering, induction soldering, resistance soldering, and/or with ultrasound.

The invention further extends to the use of the pane according to the invention in buildings or in means of locomotion for travel on land, in the air, or on water, in particular in rail vehicles or motor vehicles, as well as a windshield, rear window, side window, and/or as a roof panel, in particular as a heatable pane or as a pane with an antenna function.

The various embodiments of the invention can be implemented individually or in any combinations. In particular, the features mentioned above and to be explained below can be used not only in the combinations indicated, but also in other combinations or in isolation, without departing from the scope of the present invention.

The invention is now explained in greater detail using exemplary embodiments with reference to the accompanying figures. They depict, in simplified, not-to-scale, schematic representation:

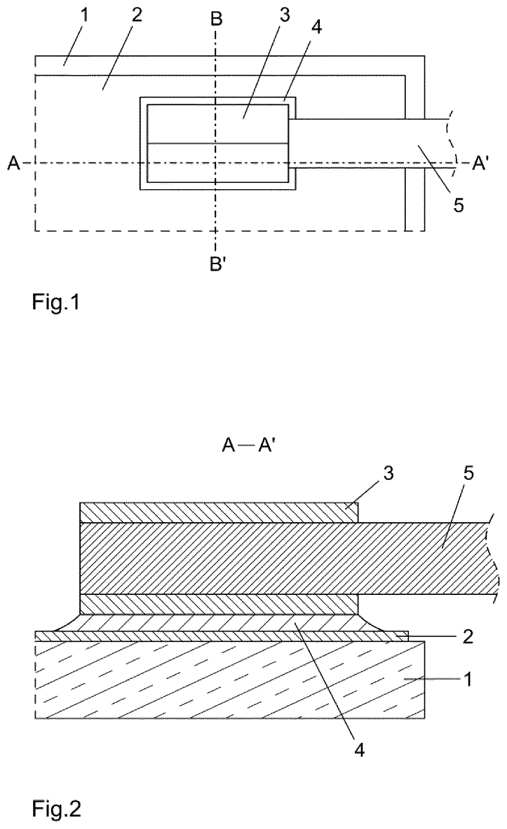

FIG. 1 a plan view of the pane according to the invention with an electric connection element before the application of the corrosion-inhibiting coating,

FIG. 2 a cross-section A-A′ through the pane of FIG. 1,

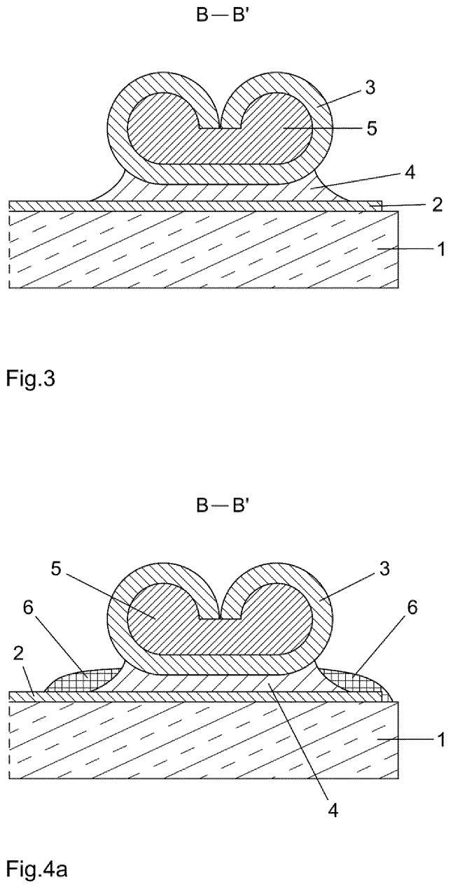

FIG. 3 a cross-section B-B′ through the pane of FIG. 1,

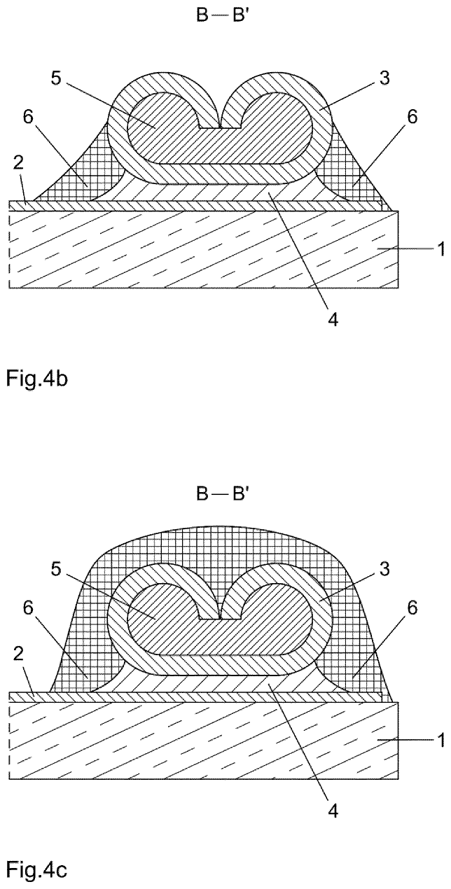

FIG. 4a a cross-section B-B′ through a first embodiment of the pane according to the invention with an electric connection element after the application of the corrosion-inhibiting coating,

FIG. 4b a cross-section B-B′ through another embodiment of the pane according to the invention with an electric connection element after the application of the corrosion-inhibiting coating,

FIG. 4c a cross-section B-B′ through another embodiment of the pane with an electric connection element after the application of the corrosion-inhibiting coating, which is not claimed in the patent claims.

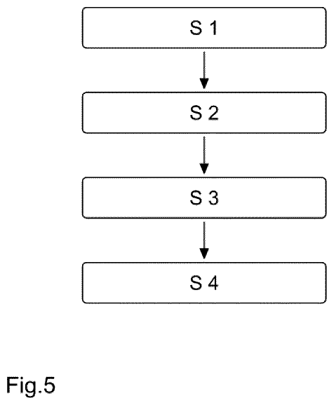

FIG. 5 a detailed flow chart of the method according to the invention.

FIG. 1, FIG. 2, and FIG. 3 depict in each case a detail of a pane according to the invention before the application of a corrosion-inhibiting coating in the region of the electric connection element 3. The pane comprises a substrate 1, which is, for example, a 3-mm-thick thermally toughened single pane safety glass made of soda lime glass. The substrate 1 has, for example, a width of 150 cm and a height of 80 cm. An electrically conductive coating 2 that serves as a heating conductor is printed on the substrate 1. The electrically conductive coating 2 contains silver particles and glass frits. In the edge region of the pane, the electrically conductive coating 2 is widened to a width of 10 mm and forms a contact surface for the electric connection element 3. In the edge region of the substrate 1, there is also a masking screen print (not shown). Soldering compound 4, which establishes a permanent electrical and mechanical connection between the electric connection element 3 and the electrically conductive coating 2, is applied in the region of the contact surface between the electric connection element 3 and the electrically conductive coating 2. The soldering compound 4 is leadfree and contains, for example, 57 wt-% bismuth, 40 wt-% tin and 3 wt-% silver. The soldering compound 4 has, for example, a thickness of 250 μm.

The electric connection element 3 consists, for example, of steel of material number 1.4509 per EN 10088-2 with a coefficient of thermal expansion of 10.5×10⁻⁶/° C. in the temperature range from 20° C. to 300° C.

The connection element 3 is crimped along its entire length around the end region of a connection cable 5. The connection element 3 is thus designed overall as a crimp. The connection cable 5 contains an electrically conductive core that is formed as a conventional stranded wire conductor. The connection cable 5 further includes a polymeric insulating sheath (not shown) that is removed in the end region in order to enable the electrical contacting of the electrically conductive core of the connection cable 5 with the connection element 3. The length of the stripped region exceeds the length L of the crimp by, for example, 0.5 mm to 3 mm, in order to ensure that the connection cable 5 can be bent.

Here, the connection element 3 is designed as an open crimp. For this purpose, the connection element 3 was provided during the production of the pane as a platelet with a material thickness of, for example, 0.4 mm, which was bent around the connection cable 5 using a crimping tool and connected permanently and stably to the connection cable 5 by squeezing (crimping). The length of the connection element 3 corresponds to the length L of the crimp (crimp length) and is, for example, approx. 4.5 mm; the width of the connection element 3 (crimp width B) is, for example, approximate 2.5 mm.

The connection element 3 has the shape of a B-crimp. The lateral edges of the connection element 3 are bent around the connection cable 5 and sunk in the electrically conductive core of the connection cable 5 by piercing of the crimping tool, whereby the wire strands of the connection cable 5 (not shown individually) move uniformly to both sides in the contact interior. The characteristic pinched shape has, in profile, two rounded coatings like the letter “B”. The characteristic pinched shape is arranged on the upper side of the connection element 3 facing away from the substrate 1. The contact surface between the connection element 3 and the soldering compound 4 is arranged opposite the characteristic pinched shape, i.e., on the crimp base. In this way, advantageous wetting of the connection element 3 with the soldering compound 4 is achieved.

In order to avoid unnecessary repetitions, in FIGS. 4a, 4b, and 4c described in the following, only the design of the corrosion-inhibiting coating 6 is explained. Otherwise, reference is made to the above statements regarding FIGS. 1, 2, and 3.

FIG. 4a depicts a cross-section along B-B′ through a first embodiment of the pane according to the invention with the electric connection element 3 implemented as a B-crimp after the application of the corrosion-inhibiting coating 6. The corrosion-inhibiting coating 6 is continuous and is adjacent the soldering compound 4. The corrosion-inhibiting coating 6 is applied to the electrically conductive coating 2 as well as (only) in sections to the soldering compound 4. The corrosion-inhibiting coating 6 is made of an electrically insulating material that also protects against moisture, consisting here, for example, of a flux with a high rosin content. The corrosion-inhibiting coating 6 always has, starting from the soldering compound 4, on the electrically conductive coating 2, relative to the plane of the substrate 1 and perpendicular to the soldering compound 4, a dimension of at least 1 mm. As a result, corrosion of the electrically conductive coating 2 that is triggered by moisture entering from the environment (electro-corrosion) can advantageously be inhibited. In addition, a mechanically stable connection between the connection element 3 and the electrically conductive coating 2 is achieved. The connection thus established between the connection element 3 and the electrically conductive coating 2 is sufficiently strong mechanically to be able to be used even in the heating field of a window, for example, a vehicle pane.

FIG. 4b depicts a cross-section along B-B′ through another embodiment of the pane according to the invention with the electric connection element 3 implemented as a B-crimp after the application of the corrosion-inhibiting coating 6, with only the differences relative to FIG. 4a explained. In contrast to the embodiment of FIG. 4a, the corrosion-inhibiting coating 6 in FIG. 4b covers the soldering compound 4 completely and covers the connection element 3 partially, i.e., not completely. Thus, in an advantageous manner, particularly good corrosion inhibition and, in addition, a mechanically very stable connection between the connection element 3 and the electrically conductive coating 2 can be achieved.

FIG. 4c depicts a cross-section along B-B′ through another embodiment of the pane with the electric connection element 3 implemented as a B-crimp after the application of the corrosion-inhibiting coating 6, with only the differences relative to FIG. 4a explained. The embodiment of FIG. 4c, which is not claimed in the patent claims, differs from the embodiment of FIG. 4a in that the corrosion-inhibiting coating 6 completely encloses or encapsulates both the soldering compound 4 and the connection element 3 implemented as a B-crimp.

The electrically conductive coating 2 depicted in the figures can, alternatively, also be construed as a special connection surface, for example, a bus bar that is applied on an (actual) functional surface. The above statements apply analogously.

FIG. 5 depicts in detail, using a flow chart, a method according to the invention for producing a pane with an electric connection element 3. In a first step (S1), soldering compound is applied to the underside of the connection element and/or to the electrically conductive coating. In a second step (S2), the connection element with interposed soldering compound is arranged on a region of the electrically conductive coating. In a third step (S3), the connection element is connected, with energy input, to the electrically conductive coating. In a fourth step (S4), a corrosion-inhibiting coating, adjacent the soldering compound, is applied on the electrically conductive coating and, at least in sections, on the soldering compound.

As can be seen from the statements above, the corrosion-inhibiting coating can advantageously delay or prevent the corrosion-induced brittleness of the solder joint between the connection element and the electrically conductive coating that sets in over time, with corrosion of the electrically conductive coating by moisture entering from the environment being inhibited. In particular, this makes it possible for the electric connection element to be used even in a heating field of a pane where it is exposed to strong temperature shocks. The pane according to the invention with an electric connection element can be produced simply and economically in industrial series production.

### LIST OF REFERENCE CHARACTERS

1 substrate
2 electrically conductive coating
3 connection element
4 soldering compound
5 connection cable
6 corrosion-inhibiting coating

1. A pane with at least one electric connection element, comprising:
a flat substrate,
an electrically conductive coating on the flat substrate,
on the electrically conductive coating, an electric connection element having a region crimped about a connection cable, wherein the crimped region is electrically conductively connected to the electrically conductive coating via a soldering compound,
a corrosion-inhibiting coating, which is applied, adjacent the soldering compound, on the electrically conductive coating and, at least in sections, on the soldering compound, wherein the corrosion-inhibiting coating is made of an electrically insulating material that protects against moisture,
wherein the corrosion-inhibiting coating
(i) only partially covers the soldering compound and does not cover the crimped region of the connection element, or
(ii) completely covers the soldering compound and only partially covers the crimped region of the connection element.

2. The pane according to claim 1, wherein the corrosion-inhibiting coating contains or consists of a sealant, a flux, a primer, a paint, a hot adhesive, or a foam tape.

3. The pane according to claim 1, wherein the corrosion-inhibiting coating on the electrically conductive coating, starting from the soldering compound and in a direction parallel to the substrate surface, always has a dimension of at least 1 mm.

4. The pane according to claim 1, wherein the substrate contains or consists of glass.

5. The pane according to claim 1, wherein the electrically conductive coating contains or consists of at least silver.

6. The pane according to claim 1, wherein the soldering compound is leadfree.

7. The pane according to claim 1, wherein the connection element is implemented in the form of a crimp, in particular as a B-crimp, and has in particular a material thickness of 0.1 mm to 2 mm.

8. The pane according to claim 1, wherein a difference between a coefficient of thermal expansion of the substrate and a coefficient of thermal expansion of the connection element is less than 5×10⁻⁶/° C.

9. The pane according to claim 1, wherein the connection element contains or consists of a chromium-containing steel having a chromium content greater than or equal to 10.5 wt-%.

10. A method for producing a pane with an electric connection element according to claim 1, comprising:
S1) applying soldering compound to an underside of the connection element and/or to the electrically conductive coating,
S2) arranging the connection element on the electrically conductive coating with interposed soldering compound,
S3) connecting the connection element to the electrically conductive coating with energy input, and
S4) applying a corrosion-inhibiting coating, adjacent the soldering compound, to the electrically conductive coating and, at least in sections, to the soldering compound, wherein the corrosion-inhibiting coating consists of an electrically insulating material that protects against moisture.

11. A method comprising providing a pane according to claim 1, in a building or in a vehicle of locomotion for travel on land, in the air, or on water.

12. The pane according to claim 3, wherein the dimension is from 1 mm to 4 mm.

13. The pane according to claim 4, wherein the substrate contains or consists of flat glass, float glass, quartz glass, borosilicate glass, and/or soda lime glass.

14. The pane according to claim 5, wherein the electrically conductive coating contains or consists of silver particles and glass frits in sintered form.

15. The pane according to claim 5, wherein the electrically conductive coating has a layer thickness of 5 μm to 40 μm.

16. The pane according to claim 6, wherein the soldering compound contains or consists of tin and bismuth, indium, zinc, copper, silver, or compositions thereof.

17. The pane according to claim 7, wherein the crimp is a B-crimp.

18. The pane according to claim 7, wherein the connection element has a material thickness of 0.1 mm to 2 mm.

19. The method according to claim 11, wherein the vehicle of locomotion is a rail vehicle or a motor vehicle.

20. The method according to claim 11, wherein the pane is a windshield, a rear window, a side window, and/or as a roof panel, or a heatable pane or a pane with an antenna function.
